(19) United States
(12) Patent Application Publication
(10) Pub. No.: US 2026/0254372 A1
(43) Pub. Date: Aug. 27, 2026

(54) INVERTER AND METHOD FOR CONTROLLING THE SAME

(71) Applicant: HOYMILES POWER ELECTRONICS INC., Hangzhou (CN)

(72) Inventors: Quan LI, Hangzhou (CN); Yuxi WANG, Hangzhou (CN); Yujie ZHANG, Hangzhou (CN); Bing CHEN, Hangzhou (CN); Junxiong WU, Hangzhou (CN)

(21) Appl. No.: 19/648,969

(22) Filed: Apr. 15, 2026

Related U.S. Application Data
(63) Continuation of application No. PCT/CN2024/121508, filed on Sep. 26, 2024.

(30) Foreign Application Priority Data
Oct. 19, 2023 (CN) 202311364088.0

(51) Int. Cl. H02M 7/5387; H02M 1/14; H02M 7/487

(52) U.S. Cl. CPC H02M 7/53871; H02M 1/14; H02M 7/487

(57) ABSTRACT

An inverter and a method for controlling the same are provided. The inverter includes an inversion circuit including a first bridge arm and a second bridge arm connected between a DC input port and an AC output port of the inversion circuit and each configured as an n-level inversion topology circuit. The method includes: in a first mode, controlling the first bridge arm to output an n-level first voltage signal between a first output terminal of the AC output port and a neutral point of the inverter, and controlling the second bridge arm to output an n-level second voltage signal between a second output terminal of the AC output port and the neutral point; and in a second mode, controlling the first bridge arm and the second bridge arm to output an (n+2)-level third voltage signal between the first output terminal and the second output terminal.

### CROSS-REFERENCE TO RELATED APPLICATIONS

This application is a continuation of international patent application No. PCT/CN2024/121508, filed on Sep. 26, 2024, which itself claims priority to Chinese patent application No. 202311364088.0, filed on Oct. 19, 2023, and titled “INVERTER AND METHOD FOR CONTROLLING THE SAME”. The contents of the above identified applications are hereby incorporated herein in their entireties by reference.

### TECHNICAL FIELD

The present disclosure relates to the technical field of power electronics, and in particular, to an inverter and a method for controlling the same.

### BACKGROUND

A common control method for an inverter includes: in an off-grid state, two bridge arms of the inverter operate independently in a decoupled manner, enabling output of two-phase 120V voltage signals; and in a grid-connected state, the two bridge arms operate together, and the output two-phase voltage signals with a phase difference of 180° can be regarded as a single-phase grid voltage with a constant phase and doubled amplitude. Therefore, a relevant modulation method can be adopted to perform grid-connected modulation by using the two bridge arms as a single-phase inverter.

However, in such a modulation method, within one power frequency cycle, each bridge arm of the inverter outputs an n-level voltage signal in the off-grid state, while in the grid-connected state, the two bridge arms collectively output an n-level voltage signal. This results in underutilization of devices in the inverter and may cause relatively large inductor current ripple.

### SUMMARY

According to various embodiments of the present disclosure, an inverter and a method for controlling the same are provided.

In a first aspect, a method for controlling an inverter is provided in the present disclosure. The inverter includes an inversion circuit, and the inversion circuit includes a first bridge arm and a second bridge arm connected between a direct current (DC) input port and an alternating current (AC) output port of the inversion circuit. Each of the first bridge arm and the second bridge arm is configured as an n-level inversion topology circuit. The method includes: in a first mode, controlling the first bridge arm to output an n-level first voltage signal between a first output terminal of the AC output port and a neutral point of the inverter, and controlling the second bridge arm to output an n-level second voltage signal between a second output terminal of the AC output port and the neutral point; and in a second mode, controlling the first bridge arm and the second bridge arm to output an (n+2)-level third voltage signal between the first output terminal and the second output terminal, and n is greater than or equal to 3 and is an odd number.

In some embodiments, the DC input port includes a positive input terminal and a negative input terminal, and controlling the first bridge arm and the second bridge arm to output the (n+2)-level third voltage signal between the first output terminal and the second output terminal further includes: controlling a first switching device of the first bridge arm between the positive input terminal and the first output terminal to be turned on, and controlling a second switching device of the second bridge arm between the negative input terminal and the second output terminal to be turned on, to output a +Vdc level; and controlling a first switching device of the second bridge arm between the positive input terminal and the second output terminal to be turned on, and controlling a second switching device of the first bridge arm between the negative input terminal and the first output terminal to be turned on, to output a −Vdc level, and Vdc is an input voltage of the DC input port.

In some embodiments, controlling the first bridge arm and the second bridge arm to output the (n+2)-level third voltage signal between the first output terminal and the second output terminal further includes: controlling the first switching device of the first bridge arm between the positive input terminal and the first output terminal to be turned on, and controlling a third switching device and a fourth switching device of the second bridge arm between the second output terminal and the neutral point to be turned on, to output a +Vdc/2 level; or controlling a third switching device and a fourth switching device of the first bridge arm between the neutral point and the first output terminal to be turned on, and controlling the second switching device of the second bridge arm between the second output terminal and the negative input terminal to be turned on, to output a +Vdc/2 level; controlling the first switching device of the second bridge arm between the positive input terminal and the second output terminal to be turned on, and controlling the third switching device and the fourth switching device of the first bridge arm between the first output terminal and the neutral point to be turned on, to output a −Vdc/2 level; or controlling the third switching device and the fourth switching device of the second bridge arm between the neutral point and the second output terminal to be turned on, and controlling the second switching device of the first bridge arm between the first output terminal and the negative input terminal to be turned on, to output a −Vdc/2 level; and controlling the third switching device and the fourth switching device of the second bridge arm between the neutral point and the second output terminal to be turned on, and controlling the third switching device and the fourth switching device of the first bridge arm between the neutral point and the first output terminal to be turned on, to output a 0 level.

In some embodiments, controlling the first bridge arm and the second bridge arm to output the (n+2)-level third voltage signal between the first output terminal and the second output terminal further includes: generating, based on a first carrier wave, a second carrier wave, and a modulated wave, control signals for controlling on/off of switching devices in the first bridge arm and the second bridge arm by using a sinusoidal pulse width modulation method. A control signal for the first bridge arm is generated according to the first carrier wave and the modulated wave. A control signal for the second bridge arm is generated according to the second carrier wave and the modulated wave.

In some embodiments, a phase angle difference φ between the first carrier wave and the second carrier wave satisfies the following relationship: 0°<φ≤180°.

In some embodiments, the n-level first voltage signal or the n-level second voltage signal includes ±Vdc/2 levels and a 0 level, and the (n+2)-level third voltage signal includes ±Vdc levels, ±Vdc/2 levels, and a 0 level, and Vdc is an input voltage of the DC input port.

In some embodiments, the n-level inversion topology circuit includes a T-type n-level inversion topology circuit or an NPC-I-type n-level inversion topology circuit.

In a second aspect, an inverter is provided in the present disclosure. The inverter includes a controller and an inversion circuit. The inversion circuit includes a first bridge arm and a second bridge arm connected between a direct current (DC) input port and an alternating current (AC) output port of the inversion circuit. Each of the first bridge arm and the second bridge arm is configured as an n-level inversion topology circuit. The controller is configured to execute the method for controlling the inverter as described in the first aspect.

In some embodiments, the inverter further includes a switching circuit. The switching circuit is connected to the AC output port and the neutral point, and is configured to switch an operating mode of the inverter to enable the inverter to operate in the first mode or the second mode.

In some embodiments, the switching circuit includes at least one first switch connected to the first output terminal of the AC output port, at least one second switch connected to the second output terminal of the AC output port, and at least one third switch connected to the neutral point. When the first switch and the second switch are turned on and the third switch is turned off, the inverter operates in the second mode. When the first switch, the second switch, and the third switch are turned on, the inverter operates in the first mode.

In some embodiments, the inverter further includes a filter circuit connected between the AC output port and the switching circuit.

In some embodiments, the inverter further includes a first capacitor connected between the positive input terminal and the neutral point and a second capacitor connected between the negative input terminal and the neutral point.

In some embodiments, the n-level inversion topology circuit includes a T-type n-level inversion topology circuit or an NPC-I-type n-level inversion topology circuit.

In some embodiments, the n-level inversion topology circuit includes a three-level inversion topology circuit.

Details of one or more embodiments of the present disclosure are presented in the attached drawings and descriptions below to provide a more concise understanding of other features, purposes and advantages of the present disclosure.

### BRIEF DESCRIPTION OF THE DRAWINGS

To more clearly illustrate the technical solutions in the embodiments of the present disclosure or in the related art, the accompanying drawings used in the embodiments or the description of the related art will be briefly introduced below. It is apparent that the drawings in the following description are only some embodiments of the present disclosure. For those skilled in the art, other drawings may also be derived from these drawings without creative efforts.

FIG. 1 is a schematic diagram of a circuit structure of an inverter according to some embodiments of the present disclosure.

FIG. 2 is a schematic diagram of a circuit structure of an inverter according to some other embodiments of the present disclosure.

FIG. 3 is a schematic diagram of an equivalent operating state of an inverter when outputting a +Vdc level according to some embodiments of the present disclosure.

FIG. 4 is a schematic diagram of an equivalent operating state of an inverter when outputting a −Vdc level according to some embodiments of the present disclosure.

FIG. 5 is a schematic diagram of an equivalent operating state of an inverter when outputting a +Vdc/2 level according to some embodiments of the present disclosure.

FIG. 6 is another schematic diagram of an equivalent operating state of an inverter when outputting a +Vdc/2 level according to some embodiments of the present disclosure.

FIG. 7 is a schematic diagram of an equivalent operating state of an inverter when outputting a −Vdc/2 level according to some embodiments of the present disclosure.

FIG. 8 is another schematic diagram of an equivalent operating state of an inverter when outputting a −Vdc/2 level according to some embodiments of the present disclosure.

FIG. 9 is a schematic diagram of an equivalent operating state of an inverter when outputting a 0 level according to some embodiments of the present disclosure.

FIG. 10 is a modulation diagram of control signals for a first bridge arm and a second bridge arm according to some embodiments of the present disclosure.

FIG. 11 is a comparison diagram of voltage signals output between midpoints of two bridge arms of an inverter in a related modulation method and in some embodiments of the present disclosure.

### DETAILED DESCRIPTION

To more clearly understand objects, technical solutions, and advantages of the present disclosure, the present disclosure will be described and illustrated below with reference to the accompanying drawings and embodiments. It should be understood that the specific embodiments described herein are merely for explaining the present disclosure and are not intended to limit the present disclosure.

Unless otherwise specified, all technical and scientific terms used in the present disclosure have the same meaning as commonly understood by those skilled in the art to which the present disclosure belongs. Terms such as “a”, “an”, “one”, “the”, and “these”, in the present disclosure do not indicate a limitation in quantity, and may indicate singular or plural. Terms such as “comprise”, “include”, “have”, and any variant thereof, as used herein, are intended to cover non-exclusive inclusion. For example, a process, method, system, product, or device that includes a series of steps or modules (units) is not limited to the listed steps or modules (units), but may include steps or modules (units) that are not listed, or may include other steps or modules (units) inherent to such process, method, product, or device. Terms such as “connected”, “linked”, “coupled” referred to in the present disclosure are not limited to physical or mechanical connections, but may include electrical connections, whether direct connections or indirect connections. As used herein, “a plurality of” means two or more. A term “and/or” may be used to describe an association relationship of associated objects, and indicate that there may be three relationships. For example, “A and/or B” may indicate that there are three cases: A alone, A and B together, and B alone. Generally, a character “/” indicates that associated objects are in an “or” relationship. Terms such as “first”, “second”, and “third” referred to in the present disclosure are merely used to distinguish similar objects, and do not represent a specific ordering for the objects.

A method for controlling an inverter is provided in some embodiments of the present disclosure. The inverter includes an inversion circuit, and the inversion circuit includes a first bridge arm and a second bridge arm connected between a direct current (DC) input port and an alternating current (AC) output port of the inversion circuit. Each of the first bridge arm and the second bridge arm is configured as an n-level inversion topology circuit.

The method includes: in a first mode, controlling the first bridge arm to output an n-level first voltage signal between a first output terminal of the AC output port and a neutral point of the inverter, and controlling the second bridge arm to output an n-level second voltage signal between a second output terminal of the AC output port and the neutral point; and in a second mode, controlling the first bridge arm and the second bridge arm to output an (n+2)-level third voltage signal between the first output terminal and the second output terminal, and n is greater than or equal to 3 and is an odd number.

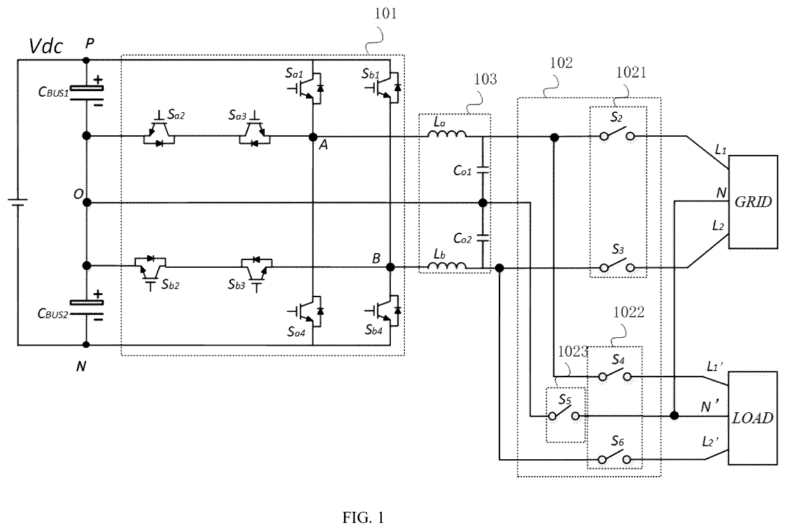

The method for controlling the inverter in the embodiments of the present disclosure may be applied to the inverter shown in FIG. 1. FIG. 1 is a schematic diagram of a circuit structure of an inverter according to some embodiments of the present disclosure. As shown in FIG. 1, the inverter includes an inversion circuit 101, and the inversion circuit 101 includes a first bridge arm and a second bridge arm connected between a direct current (DC) input port and an alternating current (AC) output port of the inversion circuit. Each of the first bridge arm and the second bridge arm is configured as an n-level inversion topology circuit, and configured to invert a DC power into an AC power. The first bridge arm may include switching devices Sₐ₁, Sₐ₂, Sₐ₃, and Sₐ₄, and the second bridge arm may include switching devices S_{b1}, S_{b2}, S_{b3}, and S_{b4}. In the present embodiment, an example in which each of the first bridge arm and the second bridge arm is configured as a T-type three-level inversion topology circuit is used for description, that is, n=3.

Furthermore, the inverter may further include a switching circuit 102 connected to an AC output port of the inversion circuit 101 and a neutral point O of the inverter. The switching circuit 102 is configured to switch an operating mode of the inverter to enable the inverter to operate in the first mode or the second mode.

Furthermore, the switching circuit 102 may be further configured to switch the inverter between a grid-connected mode and an off-grid mode.

Specifically, the switching circuit 102 may include a first switching unit 1021, a second switching unit 1022, and a third switching unit 1023. By controlling on/off states of the first switching unit 1021, the second switching unit 1022, and the third switching unit 1023, switching between the first mode and the second mode and between the grid-connected and off-grid may be achieved.

Furthermore, the first switching unit 1021 may be connected to the AC output port of the inversion circuit 101, and the first switching unit 1021 may include switches S₂ and S₃. When the switches S₂ and S₃ are turned on, the inverter may provide a grid-connected output to supply power to a grid GRID. When the switches S₂ and S₃ are turned off, power supply to the grid GRID may be stopped.

The second switching unit 1022 may be connected to the AC output port of the inversion circuit 101, and the second switching unit 1022 may include switches S₄ and S₆. when the switches S₄ and S₆ are turned on, the inverter may provide an off-grid output to supply power to a load LOAD. When the switches S₄ and S₆ are turned off, power supply to the load LOAD may be stopped.

The third switching unit 1023 may be connected to the neutral point of the inverter, and the third switching unit 1023 may include a switch S₅. When the switches S₄, S₅, and S₆ are turned on and the switches S₂ and S₃ are turned off, the inverter may perform off-grid split-phase output. Alternatively, when the switches S₂, S₃, and S₅ are turned on, the switches S₄ and S₆ are turned off, and the inverter performs grid-connected split-phase output, the inverter may operate in the first mode. When the switches S₅, S₂, and S₃ are turned off and the switches S₄ and S₆ are turned on, the inverter may perform off-grid single-phase output. Alternatively, when the switches S₄, S₅, and S₆ are turned off, the switches S₂ and S₃ are turned on, and the inverter performs grid-connected single-phase output, the inverter may operate in the second mode. When the switches S₄, S₅, and S₆ are turned off, and the switches S₂ and S₃ are turned on, the grid side may split the single-phase voltage output provided by the inverter.

Furthermore, the inverter may further include a filter circuit 103. The filter circuit 103 may be configured to filter a voltage signal provided by the inversion circuit 101, and the filter circuit 103 may include inductors Lₐ and L_{b}, and capacitors Cₒ₁ and Cₒ₂.

Moreover, the inverter may further include capacitors C_{BUS1} and C_{BUS2} connected in series at the DC input port. A connection midpoint of the capacitors C_{BUS1} and C_{BUS2} may be connected to the neutral point O of the inverter.

The DC input port may include a positive input terminal P and a negative input terminal N. The AC output port of the inversion circuit 101 may include a first output terminal and a second output terminal. A midpoint A of the first bridge arm may be defined as the first output terminal of the AC output port, and a midpoint B of the second bridge arm may be defined as the second output terminal of the AC output port.

When the inverter is in the first mode, the first bridge arm may be controlled to output a three-level first voltage signal between the first output terminal A and the neutral point O, and the second bridge arm may be controlled to output a three-level second voltage signal between the second output terminal B and the neutral point O.

When the inverter is in the second mode, the first bridge arm and the second bridge arm may be controlled to output a five-level third voltage signal between the first output terminal A and the second output terminal B.

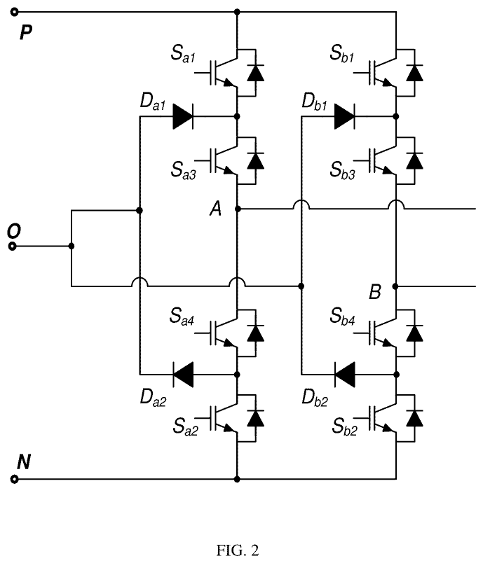

In some other embodiments, the first bridge arm and the second bridge arm described above may also have other structures, such as an NPC-I type n-level inversion topology circuit. FIG. 2 is a schematic diagram of a circuit structure of an inversion circuit of an inverter according to some other embodiments of the present disclosure. The first bridge arm may include switches Sₐ₁, Sₐ₂, Sₐ₃, and Sₐ₄, and diodes Dₐ₁ and Dₐ₂, and the second bridge arm may include switches S_{b1}, S_{b2}, S_{b3}, and S_{b4}, and diodes D_{b1} and D_{b2}.

Furthermore, in other embodiments, when each of the first bridge arm and the second bridge arm is configured as a five-level inversion topology circuit, that is, n=5, and the inverter is in the first mode, the first bridge arm may output a five-level first voltage signal between the first output terminal A and the neutral point O, and the second bridge arm may output a five-level second voltage signal between the second output terminal B and the neutral point O. When the inverter is in the second mode, the first bridge arm and the second bridge arm may be controlled to output a seven-level third voltage signal between the first output terminal A and the second output terminal B.

According to the method for controlling the inverter in at least one embodiment of the present disclosure, in the first mode, the first bridge arm may be controlled to output the n-level first voltage signal between the first output terminal of the AC output port and the neutral point of the inverter, and the second bridge arm may be controlled to output the n-level second voltage signal between the second output terminal of the AC output port and the neutral point. In the second mode, the first bridge arm and the second bridge arm may be controlled to output the (n+2)-level third voltage signal between the first output terminal and the second output terminal. A new modulation method may be proposed for the inverter, which increases the number of levels in the second mode of the inverter, reduces output ripple, lowers requirements for the filter, allows reduction in the size of the filter inductor or capacitor, lowers production costs, and improves utilization of devices in the inverter and the equivalent switching frequency of the inverter.

In some embodiments, in the second mode, controlling the first bridge arm and the second bridge arm to output the (n+2)-level third voltage signal between the first output terminal and the second output terminal may further include: controlling a first switching device of the first bridge arm between the positive input terminal and the first output terminal to be turned on, and controlling a second switching device of the second bridge arm between the negative input terminal and the second output terminal to be turned on, to output a +Vdc level; and controlling a first switching device of the second bridge arm between the positive input terminal and the second output terminal to be turned on, and controlling a second switching device of the first bridge arm between the negative input terminal and the first output terminal to be turned on, to output a −Vdc level.

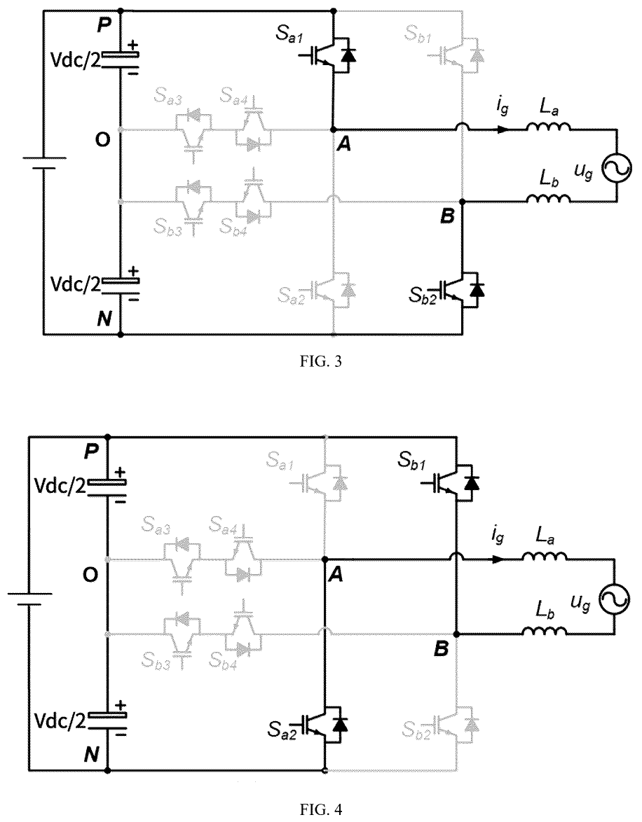

Specifically, taking the inverter shown in FIG. 1 as an example, FIG. 3 is a schematic diagram of an equivalent operating state of the inverter when outputting a +Vdc level according to some embodiments of the present disclosure. As shown in FIG. 3, when the switching device Sₐ₁ of the first bridge arm between the positive input terminal P and the first output terminal A is controlled to be turned on, and the switching device S_{b2} of the second bridge arm between the negative input terminal N and the second output terminal B is controlled to be turned on, the level of the third voltage signal output between the first output terminal A and the second output terminal B may be equal to the input voltage Vdc of the DC input port, i.e., +Vdc.

FIG. 4 is a schematic diagram of an equivalent operating state of an inverter when outputting a −Vdc level according to some embodiments of the present disclosure. As shown in FIG. 4, when the switching device S_{b1} of the second bridge arm between the positive input terminal P and the second output terminal B is controlled to be turned on, and the switching device Sₐ₂ of the first bridge arm between the negative input terminal N and the first output terminal A is controlled to be turned on, the level of the third voltage signal output between the first output terminal A and the second output terminal B may be equal to the negative value of the input voltage Vdc of the DC input port, i.e., −Vdc.

According to the method for controlling the inverter in at least some embodiments of the present disclosure, by controlling the switching device of the first bridge arm between the positive input terminal and the first output terminal to be turned on, and controlling the switching device of the second bridge arm between the negative input terminal and the second output terminal to be turned on, the +Vdc level may be output. By controlling the switching device of the second bridge arm between the positive input terminal and the second output terminal to be turned on, and controlling the switching device of the first bridge arm between the negative input terminal and the first output terminal to be turned on, the −Vdc level may be output. On the basis that the first bridge arm and the second bridge arm each output an n-level voltage signal, the first bridge arm and the second bridge arm jointly output an (n+2)-level voltage signal in the second mode. Thus, the number of output levels in the second mode of the inverter is increased, the output ripple is reduced, the requirements for the filter is reduced, the size of the inductor or the capacitor can be reduced, the production cost is lowered, and the utilization of devices in the inverter and the equivalent switching frequency of the inverter are improved.

In some embodiments, in the second mode, controlling the first bridge arm and the second bridge arm to output the (n+2)-level third voltage signal between the first output terminal and the second output terminal may further include: controlling the first switching device of the first bridge arm between the positive input terminal and the first output terminal to be turned on, and controlling a third switching device and a fourth switching device of the second bridge arm between the second output terminal and the neutral point to be turned on, to output a +Vdc/2 level; or controlling a third switching device and a fourth switching device of the first bridge arm between the neutral point and the first output terminal to be turned on, and controlling the second switching device of the second bridge arm between the second output terminal and the negative input terminal to be turned on, to output a +Vdc/2 level; controlling the first switching device of the second bridge arm between the positive input terminal and the second output terminal to be turned on, and controlling the third switching device and the fourth switching device of the first bridge arm between the first output terminal and the neutral point to be turned on, to output a −Vdc/2 level; or controlling the third switching device and the fourth switching device of the second bridge arm between the neutral point and the second output terminal to be turned on, and controlling the second switching device of the first bridge arm between the first output terminal and the negative input terminal to be turned on, to output a −Vdc/2 level; and controlling the third switching device and the fourth switching device of the second bridge arm between the neutral point and the second output terminal to be turned on, and controlling the third switching device and the fourth switching device of the first bridge arm between the neutral point and the first output terminal to be turned on, to output a 0 level.

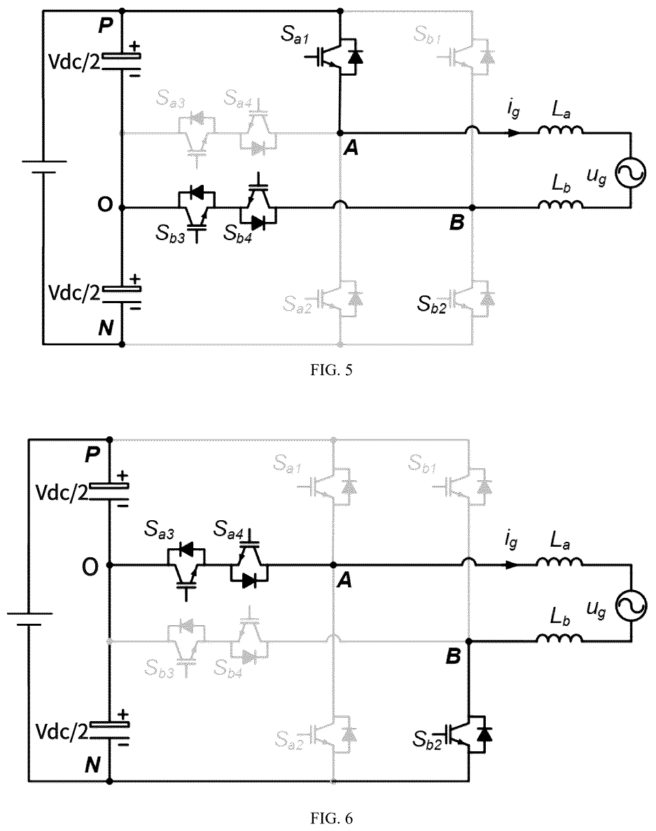

Specifically, taking the inverter shown in FIG. 1 as an example, FIG. 5 is a schematic diagram of an equivalent operating state of the inverter when outputting a +Vdc/2 level according to some embodiments of the present disclosure. As shown in FIG. 5, when the switching device Sₐ₁ of the first bridge arm between the positive input terminal P and the first output terminal A is controlled to be turned on, and the switching devices S_{b3} and S_{b4} of the second bridge arm between the second output terminal B and the neutral point O are controlled to be turned on, the level of the third voltage signal output between the first output terminal A and the second output terminal B may be equal to half of the input voltage Vdc of the DC input port, i.e., +Vdc/2.

FIG. 6 is another schematic diagram of an equivalent operating state of the inverter when outputting a +Vdc/2 level according to some embodiments of the present disclosure. As shown in FIG. 6, when the switching devices Sₐ₃ and Sₐ₄ of the first bridge arm between the neutral point O and the first output terminal A are controlled to be turned on, and the switching device S_{b2} of the second bridge arm between the second output terminal B and the negative input terminal N is controlled to be turned on, the level of the third voltage signal output between the first output terminal A and the second output terminal B may be equal to half of the input voltage Vdc of the DC input port, i.e., +Vdc/2.

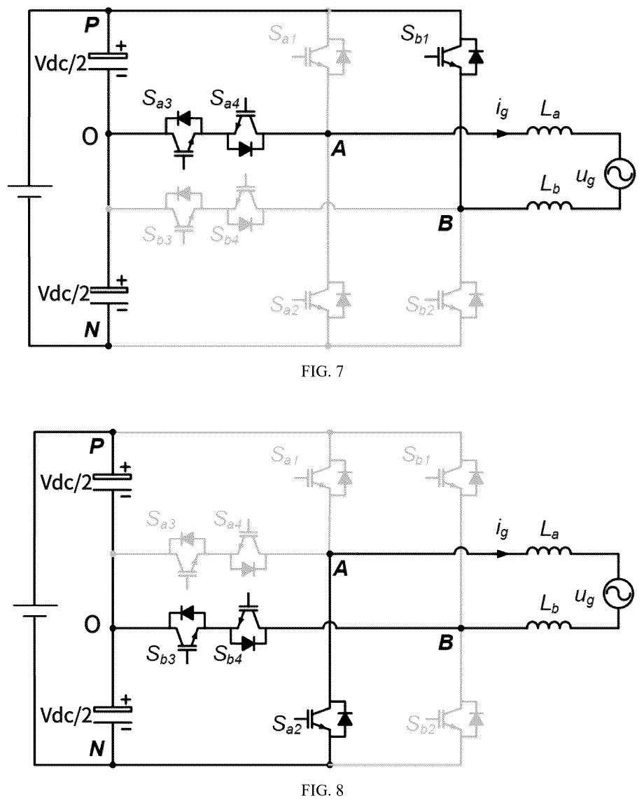

FIG. 7 is a schematic diagram of an equivalent operating state of the inverter when outputting a −Vdc/2 level according to some embodiments of the present disclosure. As shown in FIG. 7, when the switching device S_{b1} of the second bridge arm between the positive input terminal P and the second output terminal B is controlled to be turned on, and the switching devices Sₐ₃ and Sₐ₄ of the first bridge arm between the first output terminal A and the neutral point O are controlled to be turned on, the level of the third voltage signal output between the first output terminal A and the second output terminal B may be equal to half of the negative value of the input voltage Vdc of the DC input port, i.e., −Vdc/2.

FIG. 8 is another schematic diagram of an equivalent operating state of the inverter when outputting a −Vdc/2 level according to some embodiments of the present disclosure. As shown in FIG. 8, when the switch devices S_{b3} and S_{b4} of the second bridge arm between the neutral point O and the second output terminal B are controlled to be turned on, and the switch device Sₐ₂ of the first bridge arm between the first output terminal A and the negative input terminal N is controlled to be turned on, the level of the third voltage signal output between the first output terminal A and the second output terminal B may be equal to half of the negative value of the input voltage Vdc of the DC input port, i.e., −Vdc/2.

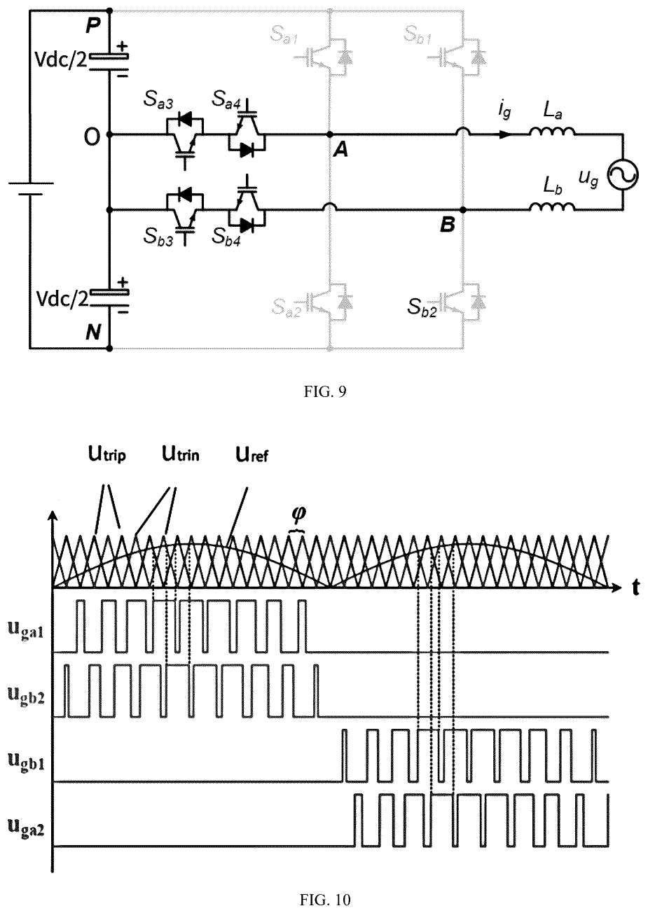

FIG. 9 is a schematic diagram of an equivalent operating state of the inverter when outputting a 0 level according to some embodiments of the present disclosure. As shown in FIG. 9, when the switching devices S_{b3} and S_{b4} of the second bridge arm between the neutral point O and the second output terminal B are controlled to be turned on, and the switching devices Sₐ₃ and Sₐ₄ of the first bridge arm between the neutral point O and the first output terminal A are controlled to be turned on, the level of the third voltage signal output between the first output terminal A and the second output terminal B may be equal to 0.

According to the method for controlling the inverter in at least one embodiment of the present disclosure, by controlling operating states of different switching devices on the first bridge arm and the second bridge arm, the +Vdc/ 2, −Vdc/2, and 0 levels may be output between the first output terminal and the second output terminal, thereby achieving that in the second mode, the first bridge arm and the second bridge arm jointly output an (n+2)-level voltage signal. This increases the number of output levels in the second mode of the inverter, improves the utilization of devices in the inverter, and reduces the inductor current ripple at the same switching frequency.

In some embodiments, controlling the first bridge arm and the second bridge arm to output the (n+2)-level third voltage signal between the first output terminal and the second output terminal may further include:
generating, based on a first carrier wave, a second carrier wave, and a modulated wave, control signals for controlling on/off of switching devices in the first bridge arm and the second bridge arm by using a sinusoidal pulse width modulation method. A control signal for the first bridge arm may be generated according to the first carrier wave and the modulated wave, and a control signal for the second bridge arm may be generated according to the second carrier wave and the modulated wave.

Specifically, FIG. 10 is a modulation diagram of control signals for a first bridge arm and a second bridge arm according to some embodiments of the present disclosure. As shown in FIG. 10, uₜᵣᵢₚ may represent the first carrier wave, uₜᵣᵢₙ may represent the second carrier wave, and u_{ref} may represent the modulated wave. Each of the first carrier wave and the second carrier wave may have a triangular waveform, or other types of waveforms. A phase angle difference between the first carrier uₜᵣᵢₚ and the second carrier uₜᵣᵢₙ may be denoted as φ, and a case that φ is equal to 180° is shown in FIG. 10. The modulated wave u_{ref} may have a sine waveform. u_{ga1}, u_{gb2}, u_{gb1}, and u_{ga2} may represent the control signals for the switching devices Sₐ₁, S_{b2}, S_{b1}, and Sₐ₂, respectively.

Specifically, the modulated wave u_{ref} may be compared to the first carrier wave uₜᵣᵢₚ, and the actions of the four switching devices Sₐ₁, Sₐ₂, Sₐ₃, and Sₐ₄ on the first bridge arm may be controlled according to the comparison result. The modulated wave u_{ref} may be compared with the second carrier wave uₜᵣᵢₙ, and the actions of the four switching devices S_{b1}, S_{b2}, S_{b3}, and S_{b4} on the second bridge arm may be controlled according to the comparison result. The switching devices Sₐ₁ and Sₐ₄ may operate complementarily, the switching devices Sₐ₂ and Sₐ₃ may operate complementarily, the switching devices S_{b1} and S_{b4} may operate complementarily, and the switching devices S_{b2} and S_{b3} may operate complementarily. Complementarity means that when one of the two switching devices is in the turned-on state, the other one is necessarily in the turned-off state.

Specifically, during a positive half cycle of the grid, the switching devices Sₐ₃ and S_{b4} may remain normally turned-on, and the switching devices S_{b1} and Sₐ₂ may remain turned-off.

When u_{ref}>uₜᵣᵢₚ and u_{ref}>uₜᵣᵢₙ, the switching devices Sₐ₁ and S_{b2} may be turned on, and the corresponding complementary switching devices Sₐ₄ and S_{b3} may be turned off. The inverter may be in the operating state shown in FIG. 3, and the output level may be u_{AB}=Vdc.

When u_{ref}>uₜᵣᵢₚ and u_{ref}<uₜᵣᵢₙ, the switching device Sₐ₁ may be turned on, the complementary switching device Sₐ₄ may be turned off, the switching device S_{b2} may be turned off, and the complementary switching device S_{b3} may be turned on. The inverter may be in the operating state shown in FIG. 5, and the output level may be u_{AB}=Vdc/2.

When u_{ref}>uₜᵣᵢₙ and u_{ref}<uₜᵣᵢₚ, the switching device Sₐ₄ may be turned on, the complementary switching device Sₐ₁ may be turned off, the switching device S_{b3} may be turned off, and the complementary switching device S_{b2} may be turned on. The inverter may be in the operating state shown in FIG. 6, and the output level may be u_{AB}=Vdc/2.

When u_{ref}<uₜᵣᵢₙ and u_{ref}<uₜᵣᵢₚ, the switching device Sₐ₄ may be turned on, the complementary switching device Sₐ₁ may be turned off, the switching device S_{b2} may be turned off, and the complementary switching device S_{b3} may be turned on. The inverter may be in the operating state shown in FIG. 9, and the output level may be u_{AB}=0.

During a negative half cycle of the grid, the switching devices S_{b4} and Sₐ₃ may remain normally on, and the switching devices Sₐ₁ and S_{b2} may remain off.

When u_{ref}<uₜᵣᵢₙ and u_{ref}<uₜᵣᵢₚ, the switching device Sₐ₂ may be turned off, the complementary switching device Sₐ₃ may be turned on, the switching device S_{b1} may be turned off, and the complementary switching device S_{b4} may be turned on. The inverter may be in the operating state shown in FIG. 9, and the output level may be u_{AB}=0.

When u_{ref}<uₜᵣᵢₙ and u_{ref}>uₜᵣᵢₚ, the switching device Sₐ₂ may be turned on, the complementary switching device Sₐ₃ may be turned off, the switching device S_{b1} may be turned off, and the complementary switching device S_{b4} may be turned on. The inverter may be in the operating state shown in FIG. 8, and the output level may be u_{AB}=−Vdc/2.

When u_{ref}>uₜᵣᵢₙ and u_{ref}<uₜᵣᵢₚ, the switching device Sₐ₂ may be turned off, the complementary switching device Sₐ₃ may be turned on, the switching device S_{b1} may be turned on, and the complementary switching device S_{b4} may be turned off. The inverter may be in the operating state shown in FIG. 7, and the output level may be u_{AB}=−Vdc/2.

When u_{ref}>uₜᵣᵢₙ and u_{ref}>uₜᵣᵢₚ, the switching device Sₐ₂ may be turned on, the complementary switching device Sₐ₃ may be turned off, the switching device S_{b1} may be turned on, and the complementary switching device S_{b4} may be turned off. The inverter may be in the operating state shown in FIG. 4, and the output level may be u_{AB}=−Vdc.

Based on the above control method, corresponding control signals may be generated to control the on/off of the switching devices in the first bridge arm and the second bridge arm. Seven different operating states can be switched within each grid cycle, and the resulting third voltage signal u_{AB} may be a five-level AC output.

In some embodiments, a phase angle difference φ between the first carrier wave and the second carrier wave satisfies the following relationship: 0°<φ≤180°.

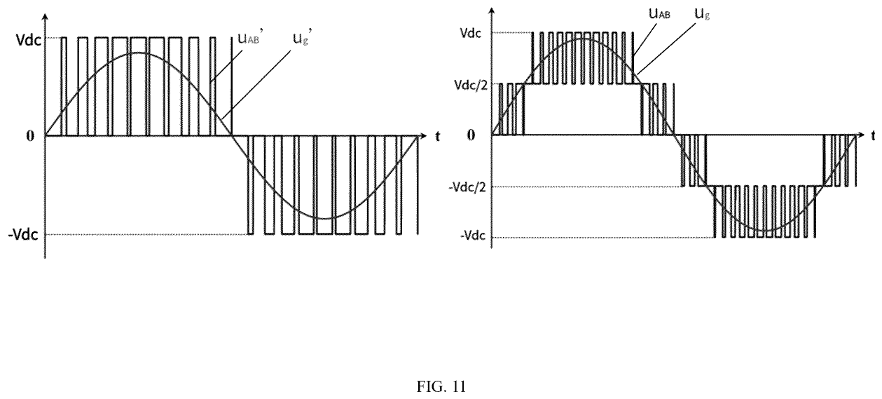

FIG. 11 is a comparison diagram of voltage signals output between midpoints of two bridge arms of an inverter in a related modulation method and in some embodiments of the present disclosure. As shown in a left diagram of FIG. 11, u_{AB}′ may represent a three-level voltage signal output between the midpoints of the two bridge arms of the inverter in the related modulation method, and u_{g}′ may represent a sinusoidal voltage signal obtained by filtering the three-level voltage signal u_{AB}′. As shown in a right diagram of FIG. 11, u_{AB} may represent a third voltage signal output between the first output terminal A and the second output terminal B of the inverter according to the present disclosure, which is a five-level voltage signal, and u_{g} may represent a sinusoidal voltage signal obtained by filtering the third voltage signal u_{AB}.

In some other embodiments, a bipolar modulation method may also be applied to generate the control signals for controlling on/off of the switching devices in the first bridge arm and the second bridge arm, to achieve the output of the (n+2)-level third voltage signal described above.

According to the method for controlling the inverter in at least one embodiment of the present disclosure, the control signals for controlling on/off of the switching devices in the first bridge arm and the second bridge arm may be generated by using a sinusoidal pulse width modulation method based on the first carrier wave, the second carrier wave, and the modulated wave. The seven different operating states can be switched within each grid cycle, achieving a differential mode voltage output of five levels, reducing the output ripple, reducing the requirements for passive filters, and lowering production costs.

In some embodiments, when the inverter is in the first mode, the n-level first voltage signal and the n-level second voltage signal may include ±Vdc/2 and 0 levels, and Vdc may be the DC input voltage of the DC input port.

When the inverter is in the first mode, an n-level first voltage signal may be output by the first bridge arm between the first output terminal of the AC output port and the neutral point of the inverter, and an n-level second voltage signal may be output by the second bridge arm between the second output terminal of the AC output port and the neutral point. The first voltage signal and the second voltage signal may include ±Vdc/2 and 0 levels.

According to the sinusoidal pulse width modulation method in some of the above embodiments, the control signals for controlling on/off of the switching devices in the first bridge arm may be generated based on corresponding carrier waves and the modulated wave, such that +Vdc/ 2, −Vdc/2, and 0 levels may be output between the first output terminal of the first bridge arm and the neutral point of the inverter. Alternatively, the control signals for controlling on/off of the switching devices in the second bridge arm may be generated based on corresponding carrier waves and the modulated wave, such that +Vdc/2, −Vdc/2, and 0 levels may be output between the second output terminal of the second bridge arm and the neutral point of the inverter.

For example, as shown in FIG. 1, when the switching devices Sₐ₁ and Sₐ₃ of the first bridge arm between the positive input terminal P and the first output terminal A are turned on and the switching devices Sₐ₂ and Sₐ₄ are turned off, the level of the first voltage signal between the first output terminal A and the neutral point O of the first bridge arm may be +Vdc/2. When the switching devices Sₐ₂ and Sₐ₄ of the first bridge arm between the negative input terminal N and the first output terminal A are turned on, and the switching devices Sₐ₁ and Sₐ₃ are turned off, the level of the first voltage signal between the first output terminal A and the neutral point O of the first bridge arm may be −Vdc/2. When the switching devices Sₐ₂ and Sₐ₃ of the first bridge arm between the neutral point O and the first output terminal A are turned on, the level of the first voltage signal between the first output terminal A and the neutral point O of the first bridge arm may be 0. The control of the second bridge arm may be similar to that of the first bridge arm and will not be described in detail.

According to the method for controlling the inverter in at least one embodiment of the present disclosure, when the inverter is in the first mode, based on independent control on the first bridge arm and the second bridge arm, +Vdc/ 2, −Vdc/2, and 0 levels may be output between the output terminals of the two bridge arms and the neutral point of the inverter separately, thereby achieving voltage signal output in the first mode of the inverter.

An inverter is further provided in the present disclosure. The inverter includes a controller and an inversion circuit, and the inversion circuit includes a first bridge arm and a second bridge arm connected between a DC input port and an AC output port of the inversion circuit. Each of the first bridge arm and the second bridge arm is configured as an n-level inversion topology circuit. The controller is configured to perform the method for controlling the inverter in the above embodiments.

According to the inverter in at least one embodiment of the present disclosure, by executing the method for controlling the inverter according to the above embodiments via the controller, it may be achieved that in the first mode, the first bridge arm and the second bridge arm may be controlled to output an n-level voltage signal respectively, and in the second mode, the first bridge arm and the second bridge arm may be controlled to jointly output an (n+2)-level voltage signal, This increases the number of levels in the second mode of the inverter, reduces the output ripple, reduces the requirements for the filter, allows reduction in the size of the inductor or capacitor, lowers production costs, and improves the utilization of the devices in the inverter and the equivalent switching frequency of the inverter.

In some embodiments, the inverter may further include a switching circuit. The switching circuit may be connected to the AC output port and the neutral point, and configured to switch an operating mode of the inverter to enable the inverter to operate in the first mode or the second mode.

When the switching circuit controls the first voltage signal between the first output terminal of the inversion circuit and the neutral point of the inverter to be output, and controls the second voltage signal between the second output terminal of the inversion circuit and the neutral point to be output, the inverter may operate in the first mode. When the switching circuit controls the third voltage signal between the first output terminal and the second output terminal of the inversion circuit of the inverter to be output, the inverter may operate in the second mode.

In some embodiments, the switching circuit may further be configured for grid-connected/off-grid switching of the inverter. When the switching circuit controls the AC output port of the inversion circuit to be connected to the grid, the inverter may perform grid-connected output. When the switching circuit controls the AC output port of the inversion circuit to be connected to the load, the inverter may perform off-grid output.

Specifically, the switching circuit may include at least one first switch connected to the first output terminal of the AC output port, at least one second switch connected to the second output terminal of the AC output port, and at least one third switch connected to the neutral point. When the first switch and the second switch are closed and the third switch is turned off, the inverter may operate in the second mode. When the first switch, the second switch, and the third switch are turned on, the inverter may operate in the first mode.

When the first switch and the second switch that control the connection between the AC output port and the grid are turned on, the inverter may perform grid-connected output. When the first switch and the second switch that control the connection between the AC output port and the load are turned on, the inverter may perform off-grid output.

In the inverter according to at least one embodiment of the present disclosure, the operating mode of the inverter may be switched by the switching circuit, so that the inverter may operate in the first mode or the second mode, thereby expanding the application range of the inverter.

In some embodiments, the inverter may further include a filter circuit connected between the AC output port of the inversion circuit and the switching circuit. The filter circuit may be configured to filter the voltage signal output from the AC output port and generate a voltage signal that meets the requirements of the grid or the load.

In some embodiments, the inverter may further include a first capacitor connected between the positive input terminal and the neutral point and a second capacitor connected between the negative input terminal and the neutral point. Each of the first capacitor and the second capacitor may be configured to filter the DC voltage input by the DC input port, thereby reducing noise of the DC voltage signal.

In some embodiments, each of the first bridge arm and the second bridge arm may be configured as a T-type n-level inversion topology circuit or NPC-I-type n-level inversion topology circuit.

In some embodiments, when each of the first bridge arm and the second bridge arm is configured as the three-level inversion topology circuit, each of the first voltage signal and the second voltage signal may include three levels, i.e., ±Vdc/2 and 0 levels, and the third voltage signal may include five levels, i.e., ±Vdc, ±Vdc/2 and 0 levels.

In some embodiments, the inverter may operate bidirectionally to perform inversion or rectification.

The inverter may be a residential photovoltaic inverter or an energy storage inverter, which is not limited in the present disclosure.

In summary, in the inverter and the method for controlling the same according to the present disclosure, by executing the method for controlling the inverter according to the above embodiments via the controller, it may be achieved that in the first mode, the first bridge arm and the second bridge arm may be controlled to output an n-level voltage signal respectively, and in the second mode, the first bridge arm and the second bridge arm may be controlled to jointly output an (n+2)-level voltage signal, This increases the number of levels in the second mode of the inverter, reduces the output ripple, reduces the requirements for the filter, allows reduction in the size of the inductor or capacitor, lowers production costs, and improves the utilization of the devices in the inverter and the equivalent switching frequency of the inverter.

It should be noted that, for specific examples in the present embodiment, reference may be made to the examples described in the above embodiments and optional implementations, and details are not repeated herein.

It should be understood that the specific embodiments described herein are merely for explaining the present disclosure and are not intended to limit the present disclosure. According to the embodiments provided in the present disclosure, all other embodiments obtained by those skilled in the art without creative efforts shall fall within the protection scope of the present disclosure.

The drawings are only some examples or embodiments of the present disclosure. For those skilled in the art, the present disclosure can be applied to other similar situations based on these drawings without creative efforts. In addition, it should be understood that although the work done during this development process may be complex and lengthy, for those skilled in the art, some changes such as certain design, manufacture, or production performed according to the technical content disclosed in the present disclosure are merely conventional technical means, and should not be considered as insufficient disclosure of the present disclosure.

The term “embodiment” in the present disclosure means that a specific feature, structure, or characteristic described in connection with the embodiment may be included in at least one embodiment of the present disclosure. The appearances of such phrase in various places in the description do not necessarily refer to the same embodiment, nor nor does it imply independent or alternative embodiments to other embodiments that are mutually exclusive. It can be clearly or implicitly understood by those skilled in the art that the embodiments described in the present disclosure may be combined with other embodiments without conflict.

The above embodiments only illustrate several implementations of the present disclosure, and the description thereof is specific and detailed, but cannot therefore be understood as limiting the protection scope of the present disclosure. It should be noted that those skilled in the art may further make variations and improvements without departing from the conception of the present disclosure, and these all fall within the protection scope of the present disclosure. Therefore, the protection scope of the present disclosure should be subjected to the appended claims.

What is claimed is:

1. A method for controlling an inverter, wherein the inverter comprises an inversion circuit, the inversion circuit comprises a first bridge arm and a second bridge arm connected between a direct current (DC) input port and an alternating current (AC) output port of the inversion circuit, each of the first bridge arm and the second bridge arm is configured as an n-level inversion topology circuit, and the method comprises:
in a first mode, controlling the first bridge arm to output an n-level first voltage signal between a first output terminal of the AC output port and a neutral point of the inverter, and controlling the second bridge arm to output an n-level second voltage signal between a second output terminal of the AC output port and the neutral point; and
in a second mode, controlling the first bridge arm and the second bridge arm to output an (n+2)-level third voltage signal between the first output terminal and the second output terminal, wherein n is greater than or equal to 3 and is an odd number.

2. The method of claim 1, wherein the DC input port comprises a positive input terminal and a negative input terminal, and controlling the first bridge arm and the second bridge arm to output the (n+2)-level third voltage signal between the first output terminal and the second output terminal further comprises:
controlling a first switching device of the first bridge arm between the positive input terminal and the first output terminal to be turned on, and controlling a second switching device of the second bridge arm between the negative input terminal and the second output terminal to be turned on, to output a +Vdc level; and
controlling a first switching device of the second bridge arm between the positive input terminal and the second output terminal to be turned on, and controlling a second switching device of the first bridge arm between the negative input terminal and the first output terminal to be turned on, to output a −Vdc level, wherein Vdc is an input voltage of the DC input port.

3. The method of claim 2, wherein controlling the first bridge arm and the second bridge arm to output the (n+2)-level third voltage signal between the first output terminal and the second output terminal further comprises:
controlling the first switching device of the first bridge arm between the positive input terminal and the first output terminal to be turned on, and controlling a third switching device and a fourth switching device of the second bridge arm between the second output terminal and the neutral point to be turned on, to output a +Vdc/2 level; or
controlling a third switching device and a fourth switching device of the first bridge arm between the neutral point and the first output terminal to be turned on, and controlling the second switching device of the second bridge arm between the second output terminal and the negative input terminal to be turned on, to output a +Vdc/2 level;
controlling the first switching device of the second bridge arm between the positive input terminal and the second output terminal to be turned on, and controlling the third switching device and the fourth switching device of the first bridge arm between the first output terminal and the neutral point to be turned on, to output a −Vdc/2 level; or
controlling the third switching device and the fourth switching device of the second bridge arm between the neutral point and the second output terminal to be turned on, and controlling the second switching device of the first bridge arm between the first output terminal and the negative input terminal to be turned on, to output a −Vdc/2 level; and
controlling the third switching device and the fourth switching device of the second bridge arm between the neutral point and the second output terminal to be turned on, and controlling the third switching device and the fourth switching device of the first bridge arm between the neutral point and the first output terminal to be turned on, to output a 0 level.

4. The method of claim 1, wherein controlling the first bridge arm and the second bridge arm to output the (n+2)-level third voltage signal between the first output terminal and the second output terminal further comprises:
generating, based on a first carrier wave, a second carrier wave, and a modulated wave, control signals for controlling on/off of switching devices in the first bridge arm and the second bridge arm by using a sinusoidal pulse width modulation method, wherein a control signal for the first bridge arm is generated according to the first carrier wave and the modulated wave; and a control signal for the second bridge arm is generated according to the second carrier wave and the modulated wave.

5. The method of claim 4, wherein a phase angle difference φ between the first carrier wave and the second carrier wave satisfies the following relationship: 0°<φ≤180°.

6. The method of claim 1, wherein the n-level first voltage signal or the n-level second voltage signal comprises ±Vdc/2 levels and a 0 level, and the (n+2)-level third voltage signal comprises ±Vdc levels, ±Vdc/2 levels, and a 0 level, wherein Vdc is an input voltage of the DC input port.

7. The method of claim 1, wherein the n-level inversion topology circuit comprises a T-type n-level inversion topology circuit or an NPC-I-type n-level inversion topology circuit.

8. An inverter, comprising a controller and an inversion circuit, wherein the inversion circuit comprises a first bridge arm and a second bridge arm connected between a direct current (DC) input port and an alternating current (AC) output port of the inversion circuit, and each of the first bridge arm and the second bridge arm is configured as an n-level inversion topology circuit;
the controller is configured to execute the method for controlling the inverter of claim 1.

9. The inverter of claim 8, further comprising a switching circuit, wherein the switching circuit is connected to the AC output port and the neutral point, and is configured to switch an operating mode of the inverter to enable the inverter to operate in the first mode or the second mode.

10. The inverter of claim 9, wherein the switching circuit comprises at least one first switch connected to the first output terminal of the AC output port, at least one second switch connected to the second output terminal of the AC output port, and at least one third switch connected to the neutral point; when the first switch and the second switch are turned on and the third switch is turned off, the inverter operates in the second mode; and when the first switch, the second switch, and the third switch are turned on, the inverter operates in the first mode.

11. The inverter of claim 9, further comprising a filter circuit connected between the AC output port and the switching circuit.

12. The inverter of claim 8, wherein the DC input port comprises a positive input terminal and a negative input terminal, and the inverter further comprises a first capacitor connected between the positive input terminal and the neutral point and a second capacitor connected between the negative input terminal and the neutral point.

13. The inverter of claim 8, wherein the n-level inversion topology circuit comprises a T-type n-level inversion topology circuit or an NPC-I-type n-level inversion topology circuit.

14. The inverter of claim 8, wherein the n-level inversion topology circuit comprises a three-level inversion topology circuit.
